(19) United States
(12) Patent Application Publication
(10) Pub. No.: US 2012/0015284 A1
(43) Pub. Date: Jan. 19, 2012

(54) BORON-DOPED DIAMOND COATED CARBON CATALYST SUPPORT

(75) Inventors: Belabbes Merzougui, Manchester, CT (US); Lesia V. Protsailo, Bolton, CT (US); Minhua Shao, Manchester, CT (US)

(73) Assignee: UTC POWER CORPORATION, South Windsor, CT (US)

(21) Appl. No.: 13/148,558

(22) PCT Filed: Feb. 10, 2009
(86) PCT No.: PCT/US2009/000842

§ 371 Date: Aug. 9, 2011

(51) Int. Cl. H01M 4/66; B01J 21/18; B01J 32/00

(52) U.S. Cl. 429/520; 502/439; 502/180; 502/177; 502/182; 502/185

(57) ABSTRACT

A catalyst support for an electrochemical system includes a high surface area carbon core structure and a surface modifier modifying the surface of the carbon core structure. The surface modifier includes boron-doped diamond (BDD) and a high surface area refractory material. The high surface area refractory material includes metal oxides, metal phosphates, metal borides, metal nitrides, metal silicides, metal carbides and combinations thereof.

### BACKGROUND

The present invention relates to a catalyst support. More particularly, the present disclosure relates to a surface modified high surface area carbon catalyst support for use, for example, in a fuel cell.

Electrodes containing supported metal catalyst particles are used in electrochemical cells, such as fuel cells. For example, in a conventional hydrogen fuel cell, a supported platinum catalyst is used to oxidize hydrogen gas into protons and electrons at the anode of the fuel cell. At the cathode of the fuel cell, another supported platinum catalyst triggers an oxygen reduction reaction (ORR), leading to the formation of water.

The catalyst support is typically a conductive high surface area carbon. The catalyst support provides a surface over which the catalyst particles are dispersed and stabilized. However, carbon catalyst supports in fuel cells are susceptible to corrosion that results in carbon oxidation and, as a final stage, collapse of the carbon structure. Causes of corrosion include the presence of oxygen, water, and high electrode potential, especially on the cathode side. Additionally, mixed potential resulting from the electrochemical reaction may exist locally. Corrosion causes microstructural derogation and surface chemistry changes, which may result in an irreversible loss in catalytic performance, cross-over and ultimately in the complete failure of the fuel cell.

Additionally, the carbon support may have poor interactions with the catalyst particles, which results in electrode changes, and more specifically, particle growth of catalyst particle sizes under dissolution/redeposition processes. The increase in size of the catalyst particles through dissolution/redeposition causes a loss in fuel cell performance. An improve catalyst support that resists corrosion is needed so that the performance of an electrochemical cell can be maintained.

### SUMMARY

A catalyst support for an electrochemical system includes a high surface area carbon core structure and a surface modifier modifying the surface of the carbon core structure. The surface modifier includes boron-doped diamond (BDD) and a high surface area refractory material. The high surface area refractory material includes metal oxides, metal phosphates, metal borides, metal nitrides, metal silicides, metal carbides and combinations thereof.

### BRIEF DESCRIPTION OF THE DRAWINGS

FIG. 1 is a schematic of a fuel cell that uses the catalyst support structures described herein.

FIG. 2 is a cross-sectional view of a catalyzed catalyst structure having a continuous refractory material layer and a continuous boron-doped diamond (BDD) layer.

FIG. 3 represents at cyclic voltammogram during potential cycling of a working electrode between the potential limits of 0 and 1.2 V vs. a reversible hydrogen electrode (V/rhe) for a carbon catalyst support compared with a carbon catalyst support coated with boron-doped diamond.

FIG. 4 is a cross-sectional view of a catalyzed catalyst structure having a non-continuous refractory material layer and a non-continuous BDD layer.

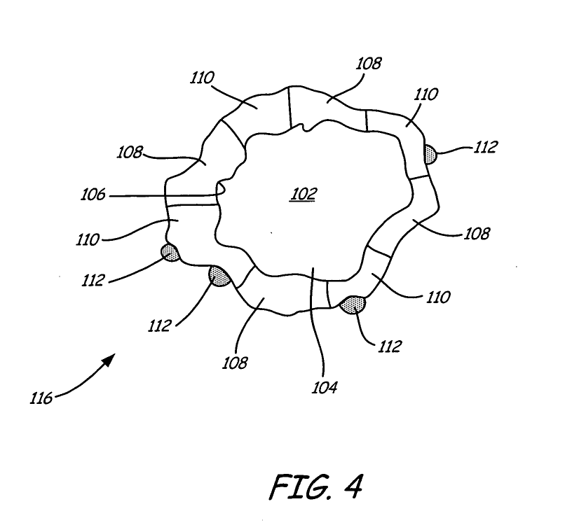

It is noted that the figures are not to scale.

### DETAILED DESCRIPTION

A stabilized catalyst support structure is described herein which includes a high surface area carbon catalyst support modified with boron doped diamond and a high surface area refractory material. The stabilized catalyst support structure can be used in fuel cells and other electrochemical devices as a support for catalyst particles, such as platinum. These catalyzed structures typically form the basis for electrochemical cell catalyst layers.

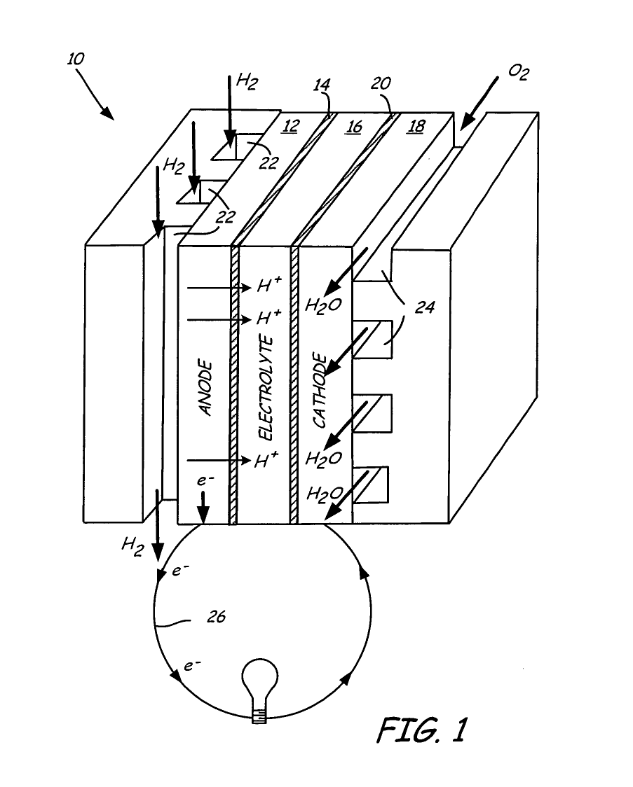

FIG. 1 is one example fuel cell 10, designed for generating electrical energy, that includes anode gas diffusion layer (GDL) 12, anode catalyst layer 14, electrolyte 16, cathode gas diffusion layer (GDL) 18, and cathode catalyst layer 20. Anode GDL 12 faces anode flow field 22 and cathode 18 GDL faces cathode flow field 24. In one example, fuel cell 10 is a fuel cell using hydrogen as fuel and oxygen as oxidant. It is recognized that other types of fuels and oxidants may be used in fuel cell 10.

Anode GDL 12 receives hydrogen gas (H₂) by way of anode flow field 22. Catalyst layer 14, which may be a platinum catalyst, causes the hydrogen molecules to split into protons (H⁺) and electrons (e⁻). While electrolyte 16 allows the protons to pass through to cathode 18, the electrons travel through an external circuit 26, resulting in a production of electrical power. Air or pure oxygen (O₂) is supplied to cathode 18 through cathode flow field 24. At cathode catalyst layer 20, oxygen molecules react with the protons from anode catalyst layer 14 to form water (H₂O), which then exits fuel cell 10, along with excess heat.

Catalyst particles dispersed and stabilized on catalyst support structures can from the basis of anode catalyst layer 14 and cathode catalyst layer 20. In one example, the catalyst particles are platinum. As described above, cathode catalyst layer 20 is used to increase the rate of the oxygen reduction reaction (ORR) ultimately resulting in the formation of water from protons, electrons and oxygen. Cathode catalyst layer 20 contains platinum as a catalyst but the platinum is unstable in this environment. During potential cycling, platinum atoms tend to dissolve and redeposit. This dissolution/redeposition process results in catalyst particle growth that decreases the performance of the fuel cell.

In one example, fuel cell 10 is a polymer electrolyte membrane (PEM) fuel cell, in which case electrolyte 16 is a proton exchange membrane formed from a solid polymer. In another example, fuel cell 10 is a phosphoric acid fuel cell, and electrolyte 16 is liquid phosphoric acid, which is typically held within a ceramic (electrically insulating) matrix.

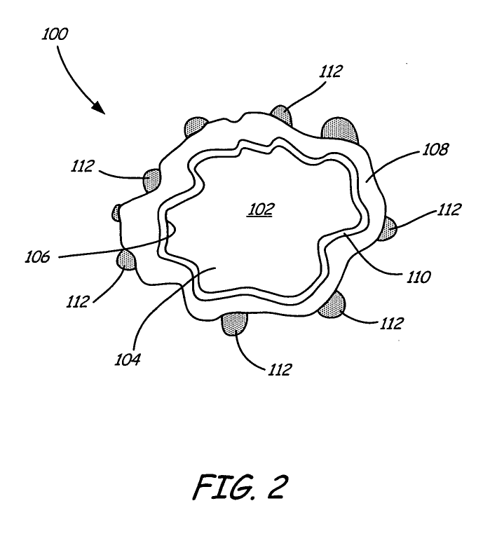

FIG. 2 is a cross-sectional view of catalyzed catalyst support structure 100 for use, for example, as basis for anode catalyst layer 14 and cathode catalyst layer 20 in fuel cell 10. Catalyzed catalyst support structure 100 includes high surface area carbon catalyst support structure or carbon core structure 102 (having inner surface 104 and outer surface 106), boron-doped diamond (BDD) 108, high surface area refractory material 110 and catalyst particles 112. For convenience, catalyzed catalyst support structure 100 will be referred to as having outer surface 114. Outer surface 114 is in contact with the environment surrounding support structure 100. High surface area carbon support structure 102 is modified by a continuous layer of BDD 108 on a continuous layer of refractory material 110. Catalyst particles 112 are dispersed and stabilized on BDD 108.

High surface area carbon support structure 102 is formed from carbon. In one example, high surface area carbon catalyst support 102 is formed from a carbon powder. In another example, high surface area carbon catalyst support 102 is formed from activated carbon or carbon black, such as Kejen Black (KB). In a further example, high surface area carbon catalyst support 102 includes at least one of mesoporous carbons, surface modified carbons, carbon nanotubes and nanowires. The high surface area of carbon support structure 102 provides an increased surface area for the dispersion of catalyst particles 112, allowing a greater number of catalyst particles 112 to be dispersed on carbon support structure 102. In one example, the carbon of carbon catalyst support 102 has a surface area between about 1 and about 3000 m²/g. Although high surface area carbon support structure 102 is shown having a generally circular cross-section, carbon support structure may have a cross-section of any shape.

BDD 108 is located at outer surface 114 of catalyst support 100 and is exposed to the surrounding environment. BDD 108 covers outer surface 114 so that BDD 108 is a continuous layer. BDD is an advanced carbon material. As will be explained in detail below, BDD 108 improves the stability of catalyst support structure 100. For example, BDD 108 provides corrosion resistance when catalyst support structure 100 is used in the presence of water, oxygen, and high electrode potential, such as the conditions present on the cathode side of a fuel cell. Although the continuous layers of BDD 108 and refractory material 110 are illustrated as having a generally homogenous thickness, the thickness of BDD 108 and refractory material 110 may be non-homogenous such that the thickness of BDD 108 and refractory material 110 vary on catalyst support structure 102.

Catalyst particles 112 can be oxidation reduction reaction (ORR) catalysts. For example, catalyst particles 112 can be catalyst particles for use in a fuel cell or other electrochemical device. In one example, catalyst particles 112 are platinum or binary, ternary or quaternary platinum alloys or combinations thereof.

Carbon catalyst support structure 102 is modified with high surface area refractory material 110. Refractory material 110 is located on outer surface 106 of carbon catalyst support structure 102, between carbon catalyst support structure 102 and BDD 108. Example refractory materials for refractory material 110 includes metal oxides, metal phosphates, metal borides, metal nitrides, metal silicides, metal carbides and combinations thereof. Further example refractory materials for refractory material 110 include TiO₂, ZrO₂, WO₃, TaO₂, Nb₂O₃, TaPOₓ, BPOₓ, ZrPOₓ, TiPOₓ, TiB₂, TiC, WC, WSi, BC, BN, SiC, ZrN, TaB₂, NbC and combinations thereof. Refractory material 110 is a high surface area compound. In one example, the refractory material has a surface area between about 10 and about 2000 m²/g. The high surface area of refractory material 110 increases the surface area of high surface area carbon support structure 102. Together refractory material 110 and carbon support structure 102 provide an increased surface area for the dispersion of catalyst particles 112.

As shown in FIG. 2, refractory material 110 can form a continuous layer on outer surface 106 of carbon catalyst support 102, and BDD 108 can form a continuous layer on refractory material 110. Refractory material 110 covers outer surface 106 of high surface area carbon support structure 102 and BDD 108 is formed over refractory material 110. Together refractory material 110 and BDD 108 modify the surface of carbon support structure 102.

Refractory material 110 and BDD 108 modify the outer surface 106 of carbon catalyst support 102, and improve and enhance catalyst support 100. Refractory material 110 stabilizes catalyst particles 112 on carbon catalyst support 102, and BDD 108 provides the conductivity necessary to use catalyzed catalyst-support structure 100 in an electrode. Refractory material 110 is stable in the high electrode potential environments presented by electrochemical systems, such as fuel cells. Additionally, refractory material 110 stabilizes the catalyst particles on the carbon support due to the strong metal-support interaction (SMSI) characteristics of the refractory material. The SMSI characteristics of refractory material 110 prevent or at least slow down the dissolution/redeposition of catalyst particles 112, enhancing the oxidation reduction reaction (ORR) activities of catalyst particles 112.

When such refractory materials are present, BDD 108 provides the necessary conductivity for catalyst support structure 102. In one example, BDD 108 has a conductivity equal to or greater than about 0.05 Siemens/centimeter (S/cm) at operating temperatures equal to or greater than about 100° C. In another example, BDD 108 has a conductivity equal to or greater than about 0.1 Siemens/centimeter (S/cm) at operating temperatures equal to or less than about 100° C. Additionally, BDD 108 plays a significant role in balancing the physical properties of catalyzed catalyst support 100. For example, the hydrophobic characteristic of BDD 108 compensates for the hydrophilic characteristic of refractory material 110. These physical properties are important for water and reactant management in an electrochemical device, such as a fuel cell.

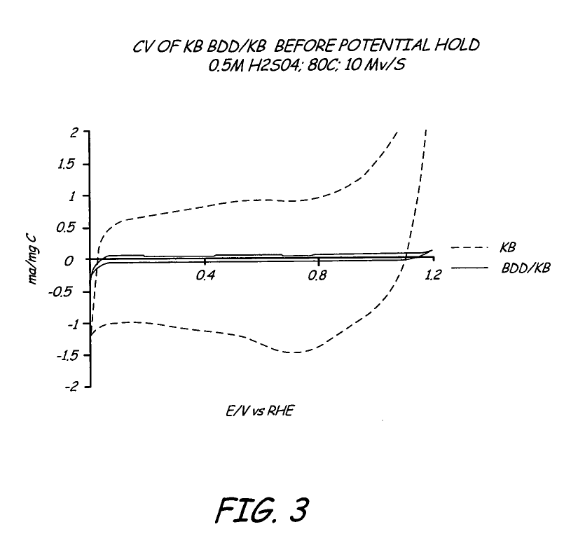

Additionally, BDD 108 provides corrosion resistance. The improved corrosion resistance of a carbon support structure coated with a layer containing BDD is illustrated in FIG. 3. FIG. 3 represents cyclic voltammograms (CV) during potential cycling in 0.5 M H₂SO₄ of two working electrodes at a scan rate of 10 mV/s between the potential limits of 0 and 1.2 V vs. a reversible hydrogen electrode (V/rhe) at a temperature of 80° C. The first electrode illustrated in the CV is an uncoated carbon support (labeled KB in FIG. 3). The uncoated carbon support was formed from Kejen Black (KB), a high surface area carbon black. The second electrode is a BDD coated carbon support (labeled BDD/KB in FIG. 3), where the carbon support was formed from Kejen Black (KB). As illustrated, the BDD coated carbon support (BDD/KB) shows an improved corrosion resistance.

Corrosion tests have also been performed at 1.4V/rhe for 5 hours in 0.5 M H₂SO₄ at 80° C. The charge per milligram of support was estimated as 4.6 C/mg for the uncoated carbon support and 2.7 C/mg for the BDD coated carbon support. Thus, the BDD coating improved the corrosion resistance of the carbon support by almost a factor of two. It is believed the combination of BDD and a high surface are refractory material will further improve the corrosion resistance of a carbon support.

High surface carbon support structure 102 having BDD 108 and refractory material 110 has an increased stability and improved corrosion resistance in harsh environments such as those present in a fuel cell. As discussed above, carbon support 102 can be a powder, and a plurality of catalyzed supports 100 can be used to form the basis of a catalyst layer of an electrode, such as anode catalyst layer 14 and cathode catalyst layer 20 in fuel cell 10 of FIG. 1. Catalyst particles 112 on catalyst support 100 experience less dissolution and redeposition during potential cycling compared to catalyst particles on a carbon support structure not modified with BDD 108 and refractory material 110. Catalyst support 100 experiences less corrosion and the performance of the fuel cell is improved.

Although BDD 108 and refractory material 110 are shown as continuous layers in FIG. 2, BDD 108 and refractory material 110 can be non-continuous layers. Catalyst support structure 116 of FIG. 5 has non-continuous layers of BDD 108 and refractory material 110 so that a mixed structure of BDD 108 and refractory material 110 is present on outer surface 106 of carbon catalyst support structure 102. In catalyzed catalyst support structure 116, portions of BDD 108 and refractory material 110 are exposed at outer surface 118 to the environment surrounding catalyst support structure 116. As illustrated, refractory material 110 forms a non-continuous layer, such as islands, on carbon support structure 102. BDD 108 is located on carbon support structure 102 between the islands of refractory material 110. Catalyst particles 112 will preferentially bond to refractory material 110 compared to BDD 108.

Refractory material 110 is a high surface area compound that will further increase the surface area for the dispersion of catalyst particles 112. Refractory material 110 also stabilizes catalyst particles 112 due to the strong metal-support interactions (SMSI) characteristics of the refractory material. BDD 108 protects portions of high surface area carbon support structure 102 that may otherwise be exposed to the harsh environment surrounding catalyst support structure 118, such a fuel cell. Additionally, BDD 108 can be located over portions of refractory material 110. In this example, refractory material 110 and BDD 108 are exposed to the environment surrounding catalyzed catalyst support structure 116 so that a mixed structure of BDD 108 and refractory material 110 is present at outer surface 118.

Together, BDD 108 and refractory material 110 modify carbon catalyst support 102 and form an improved and stabilized catalyst support. As discussed above, refractory material 110 stabilizes catalyst particles 112 on carbon support 102 due to the strong metal-support interactions (SMSI) characteristics of the refractory material. These SMSI characteristics of the refractory material slow down and may prevent the dissolution/redeposition of catalyst particles 112. Refractory material 110 enhances the oxidation reduction reaction (ORR) activity of catalyst particles 112 under a dissolution/redeposition process, and when catalyst particles 112 are platinum, refractory material 110 lowers the oxide coverage on catalyst particles 112.

BDD 108 provides the necessary conductivity to catalyst support 118 so that catalyst support 116 can be used in a fuel cell, such as fuel cell 10. As discussed above, refractory material 110 is non-conductive and is generally hydrophilic. BDD 108 is conductive and is hydrophobic, which compensates for the hydrophilic properties of refractory material 110. BDD 108 plays a significant role in balancing the physical properties, hydrophilicity and hydrophobicity, of catalyst supports 118. These physical properties are important for water and reactant management. BDD 108 also provides corrosion resistance as explained above with reference to FIG. 3.

At outer surface 118 of catalyst support structure 116, refractory material 110 and BDD 108 are exposed to the environment surrounding catalyzed catalyst support structure 116. Refractory material 110 and BDD 108 cover the carbon of carbon catalyst support structure 102 so that carbon is not exposed to the environment surrounding catalyst support structure 116. This creates a catalyst support with improved stability and corrosion resistance compared to a carbon support without BDD 108 and refractory material 110.

High surface area carbon catalyst support structures 102 having refractory material 110 and BDD 108 can be formed in a reactor using the following method. The conditions of the reactor can be varied to produce catalyst support structures having continuous layers of refractory material 110 and BDD 108, catalyst support structures having non-continuous layers of refractory material 110 and BDD 108 and catalyst support structures having combinations thereof (i.e. catalyst support structures having non-continuous layers of refractory material 110 and continuous layers of BDD 108). The method of forming modified carbon catalyst support structures includes modifying the outer surface of a high surface area carbon support with a refractory material and depositing BDD on the high surface area carbon support. The high surface area carbon support can be modified with a refractory material selected from metal oxides, metal phosphates, metal borides, metal nitrides, metal silicides, metal carbides and combinations thereof. Although only methods of modifying a carbon surface with a metal oxide and a metal carbide are disclosed, the carbon surface can be modified with any of the refractory materials listed above.

Modifying a carbon surface with a metal oxide includes mixing the carbon with a metal precursor, decomposing the precursor and applying a heat treatment. First, the carbon surface, such as a high surface area carbon powder, is mixed with a metal precursor in an inert atmosphere. In one example, the metal precursor is M(OR)ₓ where M is Ti, Nb, Ta and other suitable compounds and —OR is ethoxy, isopropoxy and other suitable compounds.

Next, the precursor is decomposed to M(OH)ₓ on the surface of the high surface area carbon support structure by exposing the carbon/metal precursor mixture to air or moisture. The decomposition of the metal precursor to M(OH)ₓ will lead to the formation of M(OH)ₓ/carbon. Finally, a heat treatment is applied the decomposed metal precursor to form metal oxide modified carbon (M—Ox/C). The heat treatment uses moderate temperatures. In one example, the heat treatment uses temperatures between about 150 and about 200° C. Depending on the conditions of the reactor, the metal oxide can form a continuous layer on the carbon support structure or the metal oxide can form islands or a non-continuous layer on the carbon support structure.

Alternatively, the carbon support structure can be modified with metal carbide. Modifying a carbon surface with metal carbide includes mixing the carbon with a metal precursor, decomposing the metal precursor on the carbon surface, heat treating the decomposed metal precursor, and passivating the system. First, the carbon is mixed with a metal precursor, such as M(OR)ₓ, in an inert atmosphere. In one example, the carbon is a high surface area carbon powder, such as Kejen Black (KB). Then, the metal precursor is decomposed on the surface of the carbon by exposing the mixture to air or moisture. The metal precursor decomposes to M(OH)ₓ on the surface of the carbon, leading to the formation of M(OH)ₓ/carbon. After decomposition of the metal precursor, a heat treatment is applied to the carbon. The carbon is heated to about 950° C. in the presence of hydrogen and methane for about two hours using a temperature programmed reaction (TPR) method to form metal carbide modified carbon (MC/C). Finally, before taking the power MC/C out, the MC/C is exposed to a mixture of gas, such as an argon-air mixture, to passive the MC/C product. The conditions of the reactor can be varied to produce a continuous layer of metal carbide or non-continuous layers of metal carbide on the carbon surface.

After the high surface area carbon support has been modified with the refractory material, BDD is deposited on the carbon support. Deposition of BDD includes introducing the carbon support modified with the high surface area refractory material into a BDD reactor and performing microwave plasma assisted chemical vapor deposition (MWPACVD). First, the modified carbon powder is introduced into a BDD reactor. A mixture of gas such as methane (CH₄), diborane (B₂H₆), hydrogen (H₂) and argon (Ar) is supplied to the reaction chamber and the pressure of the BDD reactor is adjusted to between 45 and 140 torr. Next, microwave plasma assisted chemical vapor deposition (MWPACVD) is applied. The power of the plasma generator is maintained between about 800 and 1000 watts. During the deposition process, radicals such as CH₃, H, and BH₂ are generated in the plasma and reacted with carbon surface leading to the formation of a BDD layer on the carbon catalyst support structure. The final products are modified carbon catalyst support structures. The BDD layer can be a continuous BDD layer deposited on top of a continuous layer of refractory material, a non-continuous BDD layer located between islands of refractory material or any combination thereof. After the modified carbon catalyst support structures have been created, catalyst particles can be dispersed on the surface of the carbon catalyst support structures to form catalyzed catalyst support structures. In one example the catalyst particles include platinum, binary, ternary and quaternary platinum alloys or combinations thereof.

Although the present invention has been described with reference to preferred embodiments, workers skilled in the art will recognize that changes may be made in form and detail without departing from the spirit and scope of the invention.

1. A catalyst support for an electrochemical system, the catalyst support material comprising:
a high surface area carbon core structure; and
a surface modifier modifying the surface of the core structure, wherein the surface modifier is a structure comprising:
boron-doped diamond (BDD); and
a high surface area refractory material deposited on the high surface area carbon core structure, the high surface area refractory material containing at least one member selected from the group consisting of metal oxides, metal phosphates, metal borides, metal nitrides, metal silicides, carbides and combinations thereof.

2. The catalyst support of claim 1, wherein the carbon core structure has a surface area between about 1 and about 3000 m²/g.

3. The catalyst support of claim 1, wherein the carbon core structure is selected from the group consisting of mesoporous carbons, surface modified carbons, carbon nanotubes and nanowires.

4. The catalyst support of claim 1, wherein the refractory material has a surface area between about 10 and about 2000 m²/g.

5. The catalyst support of claim 1, wherein the refractory material is selected from the group consisting of TiO₂, ZrO₂, WO₃, TaO₂, Nb₂O₃, TaPOₓ, BPOₓ, ZrPOₓ, TiPOₓ, TiB₂, TiC, WC, WSi, BC, BN, SiC, ZrN, TaB₂, NbC and combinations thereof.

6. The catalyst support of claim 1, wherein the refractory material is a continuous layer on the carbon core structure.

7. The catalyst support of claim 6, wherein the refractory material is selected from the group consisting of TiO₂, ZrO₂, WO₃, TaO₂, Nb₂O₃, TaPOₓ, BPOₓ, ZrPOₓ, TiPOₓ, TiB₂, TiC, WC, WSi, BC, BN, SiC, ZrN, TaB₂, NbC and combinations thereof.

8. The catalyst support of claim 6, wherein the BDD is located on the refractory material.

9. The catalyst support of claim 1, wherein the refractory material is a non-continuous layer on the carbon core structure.

10. The catalyst support of claim 9, wherein the refractory material is selected from the group consisting of TiO₂, ZrO₂, WO₃, TaO₂, Nb₂O₃, TaPOₓ, BPOₓ, ZrPOₓ, TiPOₓ, TiB₂, TiC, WC, WSi, BC, BN, SiC, ZrN, TaB₂, NbC and combinations thereof.

11. The catalyst support of claim 1, wherein the BDD has a conductivity greater than about 0.05 Siemens/centimeter (S/cm) at temperatures equal to or greater than about 100° C.

12. The catalyst support of claim 1, wherein the BDD has a conductivity greater than about 0.1 Siemens/centimeter (S/cm) at temperatures equal to or less than about 100° C.

13. A catalyst structure for an electrochemical cell comprising the catalyst support of claim 1, and further comprising a catalyst deposited onto the catalyst support material.

14. The catalyst structure of claim 13, wherein the catalyst is selected from the group consisting of platinum and binary, ternary and quaternary platinum alloys.

15. The catalyst structure of claim 13, wherein the refractory material is a continuous layer on the carbon core structure.

16. The catalyst structure of claim 13, wherein the refractory material is a non-continuous layer on the carbon core structure.

17. A fuel cell comprising:
an anode;
a cathode;
an anode catalyst layer; and
a cathode catalyst layer, wherein at least one of the anode catalyst layer and the cathode catalyst layer comprises:
a catalyst support structure including a carbon core structure, boron-doped diamond (BDD) modifying the carbon core structure and a high surface area refractory material containing at least one member selected from the group consisting of metal oxides, metal phosphates, metal borides, metal nitrides, metal silicides, carbides and combinations thereof, the refractory material modifying the carbon core structure and deposited on the carbon core structure; and
catalyst particles dispersed on the catalyst support structure.

18. The fuel cell of claim 17, wherein the refractory material is a continuous layer on the carbon core structure.

19. The fuel cell of claim 18, wherein the BDD is located on the continuous layer of the refractory material.

20. The fuel cell of claim 17, wherein the refractory material is a non-continuous layer on the carbon core structure.
